(19) United States
(12) Patent Application Publication
(10) Pub. No.: US 2026/0175406 A1
(43) Pub. Date: Jun. 25, 2026

(54) MOTION REPRODUCTION APPARATUS

(71) Applicant: PARAM ROBOTICS INC., Hwaseong-si, Gyeonggi-do (KR)

(72) Inventor: Gil Young LEE, Seoul (KR)

(21) Appl. No.: 19/137,826

(22) PCT Filed: Dec. 12, 2022
(86) PCT No.: PCT/KR2022/020163

§ 371 Date: Jun. 11, 2025

(51) Int. Cl. B25J 9/00

(52) U.S. Cl. CPC B25J 9/0054; B25J 9/0009

(57) ABSTRACT

Provided is a motion reproduction apparatus in which a bed onto which an object is coupled is connected to a plurality of shafts to reproduce free motion of the object and to facilitate changing of the initial direction thereof. Accordingly, a variety of motions of an object can be reproduced and the initial direction of the bed can be freely changed, thereby allowing the motions of the object to be freely reproduced under a variety of conditions.

### TECHNICAL FIELD

The present invention relates to a motion reproduction apparatus, and particularly, to a motion reproduction apparatus that reproduces a motion in six directions and allows an initial direction to be easily changed.

### BACKGROUND ART

Image correction technologies, such as optical image stabilization (OIS), for preventing shaking of photographs due to shaking of a hand when a photograph is taken through a camera, have been disclosed. A simulation device for a motion such as shaking is required to test operation performance of software and hardware according to the image correction technologies. This is because it is difficult to achieve consistent results when a person holds and shakes the camera with his or her hand.

Because shaking of a hand is not a regular motion in any one direction, it is required that the motion be simulated in all directions. To this end, a six-axis motion simulator according to the related art may be used.

However, in the six-axis motion simulator according to the related art, an initial direction of a bed coupled to an object has been determined, and a certain level or more of the motion in the initial direction cannot be reproduced. This is because an operation range of each axis has been fixed.

In particular, generally in photography, because a view angle is set in a horizontal direction with respect to the ground, the six-axis motion simulator according to the related art needs to be installed on a vertical wall surface. In this case, an installation surface is bent due to a weight of the simulator, and thus test results are not accurate or the simulator falls down.

### RELATED ART DOCUMENT

Korean Patent Registration No. 10-1992674 (registered on Jun. 19, 2019)
Korean Patent Registration No. 10-1356640 (registered on Jan. 22, 2014)

### DESCRIPTION OF THE INVENTION

### Technical Problem

The present invention is directed to providing a reproduction apparatus capable of reproducing a free motion.

The present invention is also directed to providing a motion reproduction apparatus that easily changes an initial direction.

### Technical Solution

In order to solve the above problems, the present invention discloses a motion reproduction apparatus in which a bed to which an object is coupled is driven while connected to a plurality of shafts.

### Advantageous Effects

According to the present invention, various motions of an object can be reproduced.

In addition, since an initial direction of a bed can be freely changed, the motions of the object can be reproduced under various conditions.

### DESCRIPTION OF DRAWINGS

FIG. 1 illustrates a six-axis motion simulator according to the related art.

FIG. 2 is a perspective view illustrating a motion reproduction apparatus according to an embodiment of the present invention.

FIG. 3 illustrates a bed, a driving part, and a base according to the embodiment of the present invention.

FIG. 4 illustrates a state in which an initial direction of the bed is changed in FIG. 3.

FIG. 5 is a side view of the motion reproduction apparatus according to the embodiment of the present invention.

FIG. 6 is a side view illustrating a state in which the initial direction of the bed is changed according to a change in location of a variable base.

FIG. 7 is an exploded view illustrating the driving part according to the embodiment of the present invention.

FIG. 8 illustrates a state in which the driving part according to the embodiment of the present invention is coupled.

FIG. 9 illustrates an initial state of the bed.

FIG. 10 illustrates a pitch motion of the bed in a positive direction.

FIG. 11 illustrates the pitch motion of the bed in a negative direction.

FIG. 12 illustrates a roll motion of the bed in the positive direction.

FIG. 13 illustrates the roll motion of the bed in the negative direction.

FIG. 14 illustrates a yaw motion of the bed in the positive direction.

FIG. 15 illustrates the yaw motion of the bed in the negative direction.

### BEST MODE

A motion reproduction apparatus includes a bed to which an object for reproducing a motion is coupled; a first shaft formed on one end of the bed; a second shaft formed on the other end of the bed; and a base to which a plurality of driving parts are fixedly coupled, wherein the first shaft and the second shaft move while connected to the driving parts to reproduce a pitch motion, a roll motion, and a yaw motion of the bed.

### MODES OF THE INVENTION

Terms used in the specification will be briefly described, and embodiments of the present invention will be described in detail. Although general terms currently widely used are selected as often as possible as the terms used in the specification in consideration of functions in the present invention, the terms may be changed depending on an intention of those skilled in the art, a precedent, an emergence of new technologies, etc. Further, in specific cases, terms are arbitrarily selected by the applicant, and in this case, the meaning thereof will be described in detail in the corresponding description of the invention. Thus, the terms used in the specification should be defined based not on the designation of the terms but on the meaning of the terms and the overall content of the present invention.

Embodiments of the present invention will be described in detail below with reference to the accompanying drawings.

Image correction technologies, such as optical image stabilization (OIS), for preventing shaking of photographs due to shaking of a hand when a photograph is taken through a camera, have been disclosed. A simulation device for a motion such as shaking is required to test operation performance of software and hardware according to the image correction technologies. This is because it is difficult to achieve consistent results when a person holds and shakes the camera with his or her hand.

Because shaking of a hand is not a regular motion in any one direction, it is required the motion be simulated in all directions. To this end, a six-axis motion simulator according to the related art may be used.

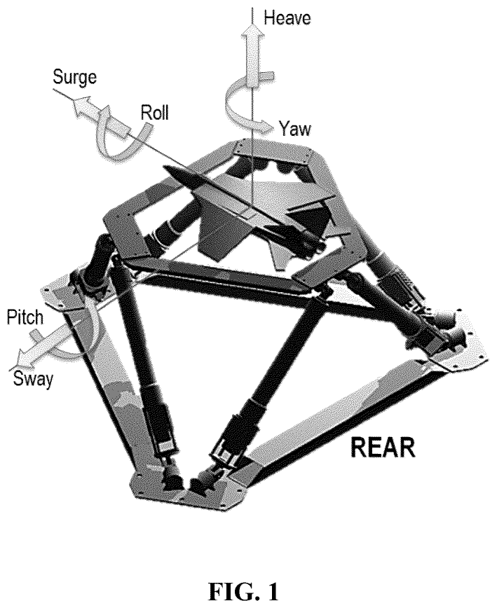

FIG. 1 illustrates the six-axis motion simulator according to the related art. The six-axis motion simulator may reproduce motions in six different directions (positive and negative directions of a pitch, a roll, and a yaw).

However, in the six-axis motion simulator according to the related art, an initial direction of a bed coupled to an object has been determined, and a certain level or more of the motion in the initial direction cannot be reproduced. This is because an operation range of each axis has been fixed.

In particular, generally in photography, because a view angle is set in a horizontal direction with respect to the ground, the six-axis motion simulator according to the related art needs to be installed on a vertical wall surface. In this case, an installation surface is bent due to a weight of the simulator, and thus test results are not accurate or the simulator falls down.

The present invention is an invention for solving the problems of the related art and discloses a motion reproduction apparatus in which an initial direction of a bed 1 with respect to the ground can be changed.

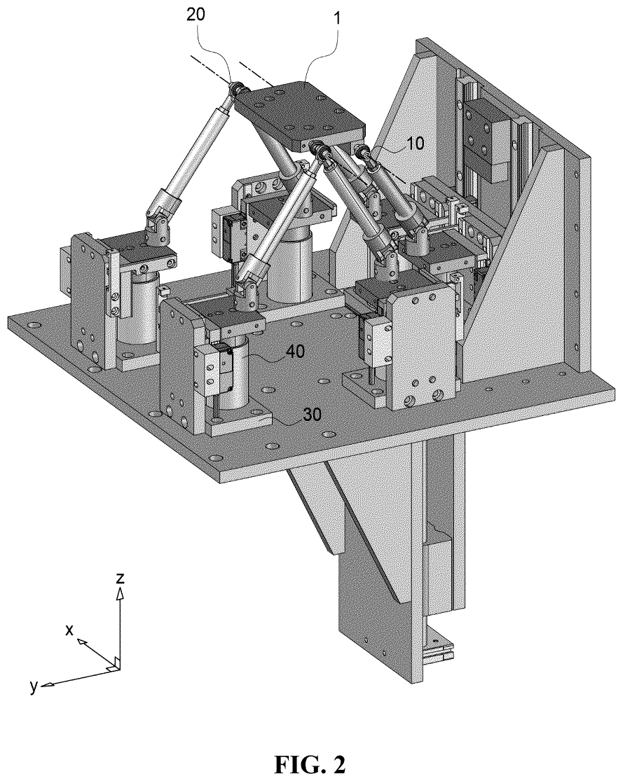

FIG. 2 is a perspective view illustrating the motion reproduction apparatus according to an embodiment of the present invention. Three arrows illustrated at the bottom left of FIG. 2 represent directions (x axis, y axis, and z axis) of a three-dimensional space expressed in the drawing (these directions are equally applied to the following drawings).

The motion reproduction apparatus according to the present invention includes a bed 1, a first shaft 10, a second shaft 20, and a base 30.

The bed 1 is a component that is coupled to an object for reproducing a motion and moves the object according to a motion of the bed 1. According to the present invention, a shape of the bed 1 is not limited to any one form. As an embodiment, the bed 1 may be provided in a plate shape. Preferably, the bed 1 may be provided such that an upper surface thereof is perpendicular to a z-axis direction and is horizontal with respect to the ground.

The first shaft 10 and the second shaft 20 are components for implementing the motion of the bed 1. In detail, the first shaft 10 is formed on one end of the bed 1, the second shaft 20 is formed on the other end of the bed 1, the first shaft 10 and the second shaft 20 are connected to a plurality of driving parts 40 to be moved, and thus, the motion of the bed 1 is implemented.

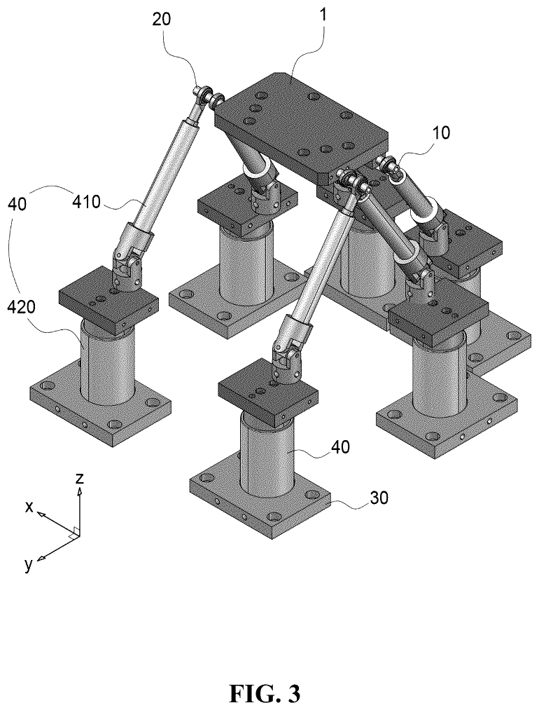

The driving part 40 is a component for moving the first shaft 10 and the second shaft 20 and is provided as a plurality of driving parts 40. Preferably, at least six driving parts 40 are provided and are connected to one end and the other end of the first shaft 10 and the second shaft 20. The driving parts 40 will be described in detail later with reference to FIG. 3.

The base 30 is a component for supporting the driving part 40. Preferably, the base 30 is provided in a form that may be fixed to the ground. More preferably, an upper surface of the base 30 is provided as a plane, and thus the driving parts 40 are fixed at different positions on the upper surface of the base 30.

As illustrated in FIG. 2, the first shaft 10 and the second shaft 20 are moved while connected to the driving parts 40 and thus reproduce a pitch motion, a roll motion, and a yaw motion of the bed 1.

Hereinafter, the “pitch motion” is defined as a two-way rotational motion of the bed 1 in which an x axis illustrated in the drawing is set as a central axis, the “roll motion” is defined as a two-way rotational motion of the bed 1 in which a y axis illustrated in the drawing is set as a central axis, and the “yaw motion” is defined as a two-way rotational motion of the bed 1 in which a z axis illustrated in the drawing is set as a central axis.

FIG. 3 illustrates the bed 1, the driving part 40, and the base 30 according to the embodiment of the present invention. In FIG. 3, for convenience of understanding, components other than the bed 1, the driving part 40, and the base 30 are not illustrated.

Preferably, the driving part 40 may include an arm 410 and a linear motion part 420.

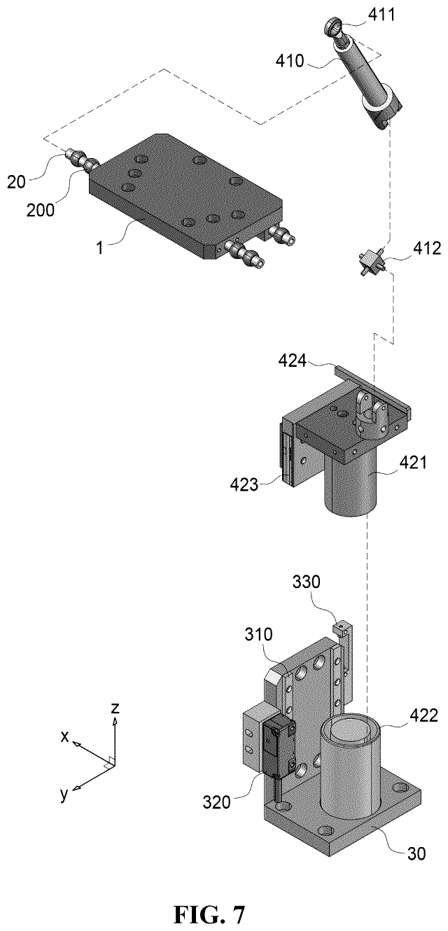

The arm 410 is a component for converting a linear motion of the linear motion part 420 into an angular motion. In detail, one end of the arm 410 is connected to the first shaft 10 or the second shaft 20, and the other end thereof is connected to one end of the linear motion part 420. Here, the one end and the other end of the arm 410 are provided in the form of a joint, and thus the linear motion of the linear motion part 420 may be converted into the angular motion. This will be described below with reference to FIG. 7.

The linear motion part 420 is a component for moving the arm 410 and has one end linearly moved within a predetermined range and the other end coupled to the base 30. According to the embodiment of the present invention, the one end of the linear motion part 420 is linearly moved in an upward and downward direction. Preferably, the linear motion part 420 may include a power part such as an electric motor or a hydraulic cylinder. Since the power part that implements the linear motion is a widely-known technology, a detailed description thereof will be omitted.

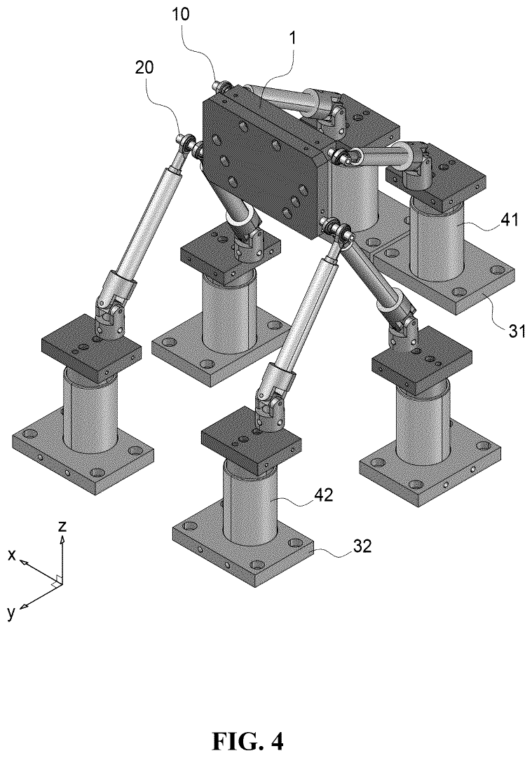

FIG. 4 illustrates a state in which the initial direction of the bed 1 of FIG. 3 is changed.

According to the embodiment of the present invention, the base 30 may be divided into a fixed base 32 and a variable base 31. The fixed base 32 is a base of which relative position with respect to the ground is fixed, and the variable base 31 is a base of which relative position with respect to the ground may be changed. A numerical ratio of the fixed base 32 to the variable base 31 is not limited, but it is preferable that at least one variable base 31 be provided.

Since the relative position of the fixed base 32 with respect to the ground is fixed, the linear motion part 420 connected thereto is also fixed with respect to the ground.

On the other hand, since the relative position of the variable base 31 with respect to the ground changes, the linear motion part 420 connected thereto may also be changed with respect to the ground, and accordingly, a relative position with respect to the fixed base 32 may be changed. When a plurality of variable bases 31 are provided, it is obvious that a relative position between the variable bases 31 may be changed.

Hereinafter, the driving part 40 connected to the variable base 31 is referred to as a “first driving part 41,” and the driving part 40 connected to the fixed base 32 is referred to as a “second driving part 42.”

At least one of the first shaft 10 and the second shaft 20 is connected to the first driving part 41. In the embodiment of the specification, a description will be made based on the first shaft 10 connected to the first driving part 41.

As a relative position of the first driving part 41 with respect to the second driving part 42 is changed due to the variable base 31, an initial position of the first shaft 10 connected to the first driving part 41 may be changed. On the other hand, an initial position of the second shaft 20 connected to the second driving part 42 is fixed. Accordingly, the initial direction of the bed 1 may be changed.

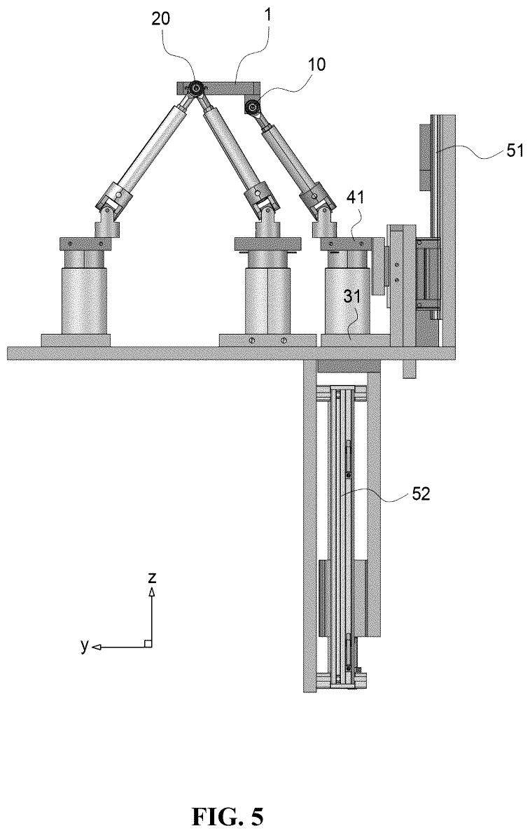

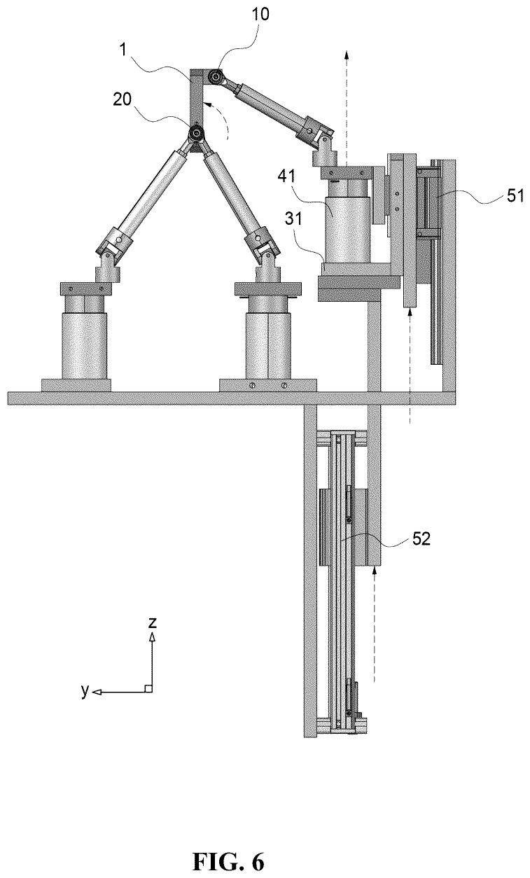

FIG. 5 is a side view (illustrating an y-z plane in a x-axis direction) of the motion reproduction apparatus according to the embodiment of the present invention, and FIG. 6 is a side view illustrating a state in which the initial direction of the bed 1 is changed according to the change in the position of the variable base 31.

Preferably, the variable base 31 may be moved due to at least one guide part that is provided so that a position thereof may be changed.

As an exemplary embodiment, the guide part may include a first guide part 51 and a second guide part 52 provided in the shape of a vertical pillar. The first guide part 51 may be formed on one surface of the variable base 31, the variable base 31 may be guided and moved by the first guide part 51, and thus shaking of the variable base 31 can be prevented.

The second guide part 52 is formed below the variable base 31, supports a lower portion of the variable base 31, and guides movement of the variable base 31.

In this way, the plurality of guide parts at different positions may guide the movement of the variable base 31, and thus the shaking of the variable base 31 due to operating the first driving part 41 can be prevented.

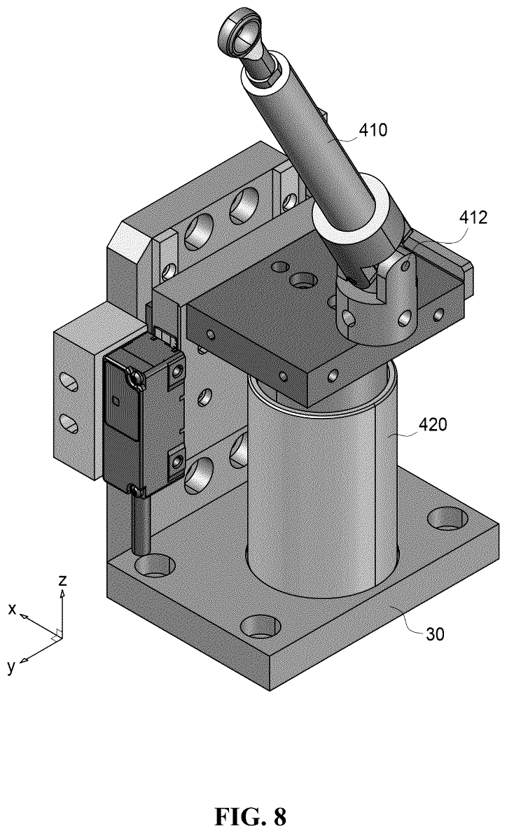

FIG. 7 is an exploded view illustrating the driving part 40 according to the embodiment of the present invention, and FIG. 8 is a view illustrating a state in which the driving part 40 according to the embodiment of the present invention is coupled.

Preferably, the one end of the arm 410 is connected to the first shaft 10 or the second shaft 20 through a spherical bearing 200. In detail, a plurality of spherical bearings 200 may be coupled to one end and the other end of the first shaft 10, the one end of the arm 410 may be incised into a spherical shape, and thus the motion of the arm 410 may be converted into a motion of the first shaft 10 or the second shaft 20.

Further, a biaxial connection part 412 may be provided at the other end of the arm 410. The biaxial connection part 412 is provided to have two pins perpendicular to each other, one pin thereof is inserted into a hole formed in the other end of the arm 410, and the other pin thereof is inserted into a hole formed in the one end of the linear motion part.

The spherical bearing 200 provided at the one end of the arm 410 and the biaxial connection part 412 provided at the other end thereof may change a direction of a force transmitted from the linear motion part 420 so that the linear motion of the linear motion part 420 is converted into the motion of the bed 1.

The linear motion part 420 may include an outer cylinder 422 coupled to the base 30 and an inner cylinder 421 inserted into the outer cylinder 422 and linearly moved by the power part. The power part transfers power to the inner cylinder 421 through the outer cylinder 422 so as to move the inner cylinder 421.

As an exemplary embodiment, a gradation portion 423 may be connected to the inner cylinder 421. The gradation portion 423 is a component for measuring displacement of the inner cylinder 421 and may be formed on a side surface of the inner cylinder 421.

Further, the sensor unit 320 for detecting movement of the gradation portion 423 may be provided. A person may directly measure the displacement of the inner cylinder 421 through the gradation portion 423, or by detecting the displacement of the gradation portion 423 through the sensor unit 320, may measure the displacement of the inner cylinder 421 so as to measure the displacement more accurately. Accordingly, a more accurate test can be achieved.

As an exemplary embodiment, a rail part 310 coupled to the base 30 may be further included. The rail part 310 is a component for guiding the linear motion of the linear motion part 420. According to the embodiment of the present invention, the rail part 310 may be formed in the shape of a vertical column and coupled to the base 30, the inner cylinder 421 may move along the rail part 310, and thus a linear motion of the inner cylinder 421 can be stabilized.

As an exemplary embodiment, a separation preventing part may be further included. The separation preventing part is a component for preventing separation of the inner cylinder 421 by limiting a linear motion operation range of the inner cylinder 421. According to the embodiment, a protrusion 424 may be formed on one surface of the inner cylinder 421, a jaw portion 330 formed in the base 30 may be formed on a movement path of the protrusion 424, and thus the operation range of the inner cylinder 421 can be limited.

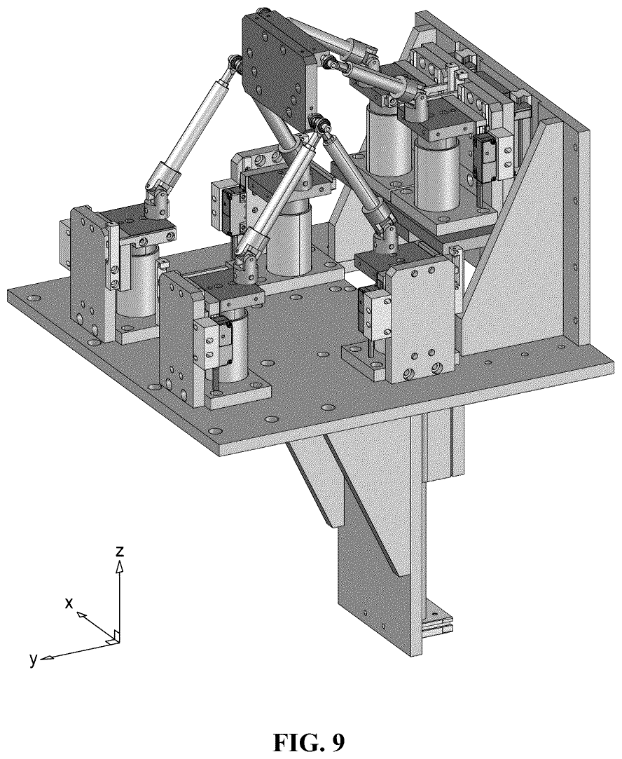

FIGS. 9 to 15 illustrate an operation state of the motion reproduction apparatus according to the embodiment of the present invention.

FIG. 9 illustrates an initial state of the bed 1.

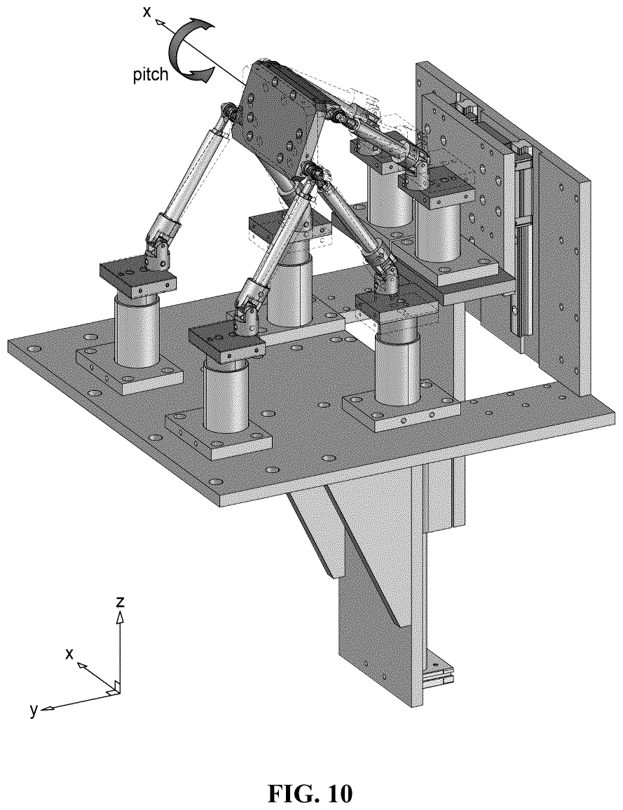

FIG. 10 illustrates a pitch motion of the bed 1 in a positive direction.

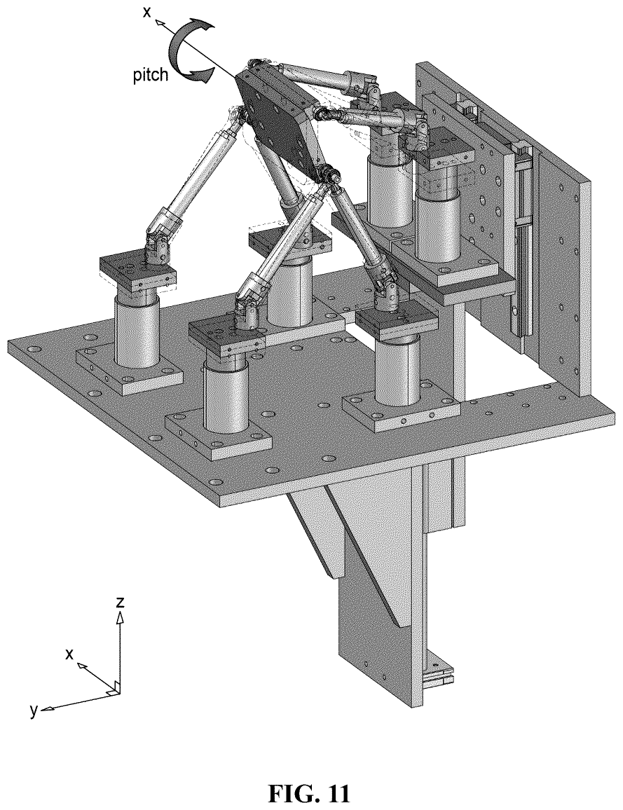

FIG. 11 illustrates the pitch motion of the bed 1 in a negative direction.

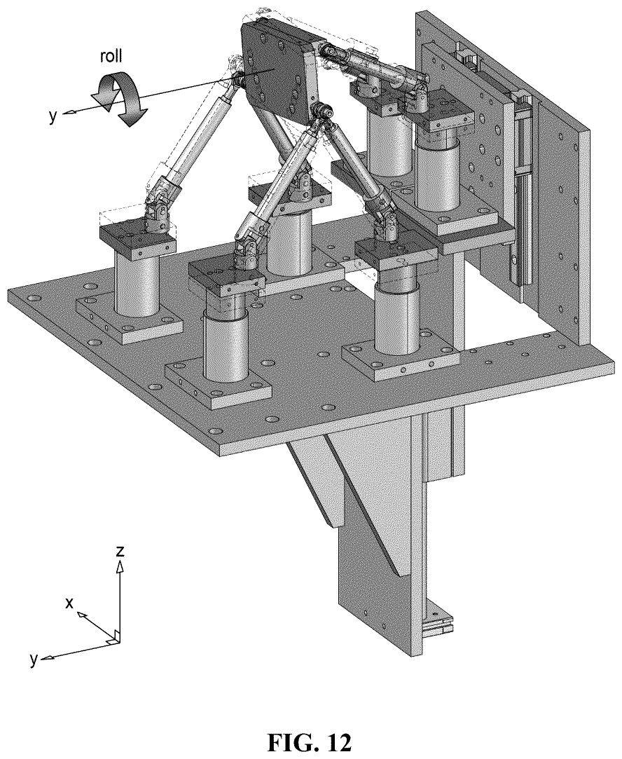

FIG. 12 illustrates a roll motion of the bed 1 in the positive direction.

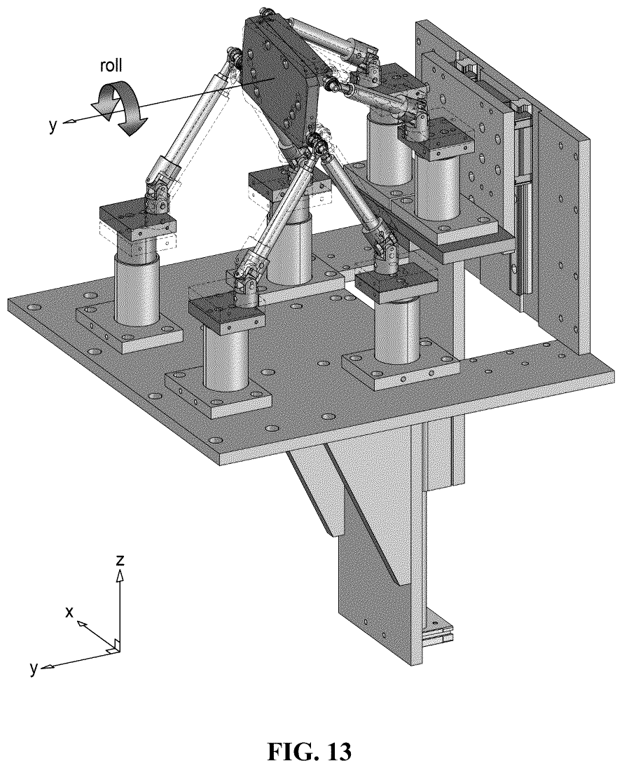

FIG. 13 illustrates the roll motion of the bed 1 in the negative direction.

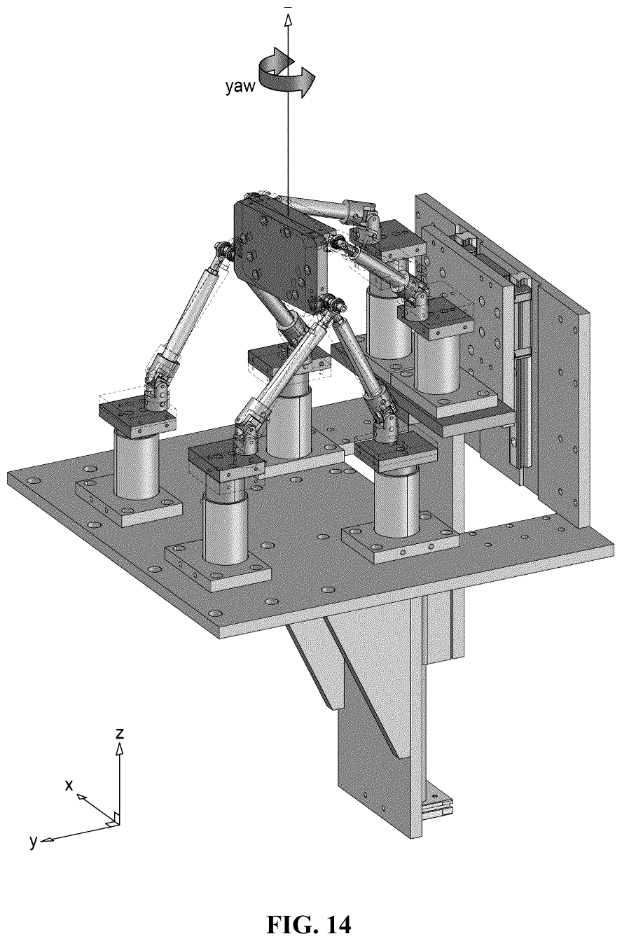

FIG. 14 illustrates a yaw motion of the bed 1 in the positive direction.

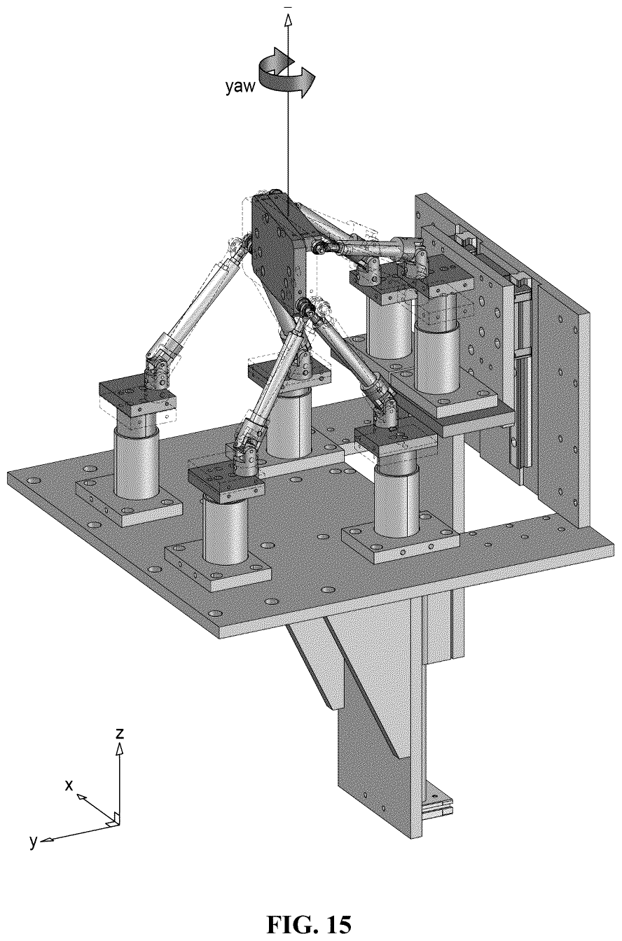

FIG. 15 illustrates the yaw motion of the bed 1 in the negative direction.

Dotted lines illustrated in FIGS. 10 to 15 indicate positions of the bed 1 and the driving part in the initial state.

As illustrated in FIGS. 10 to 15, the linear motion of the inner cylinder 421 may be converted into the angular motion of the bed 1 by the arm 410 in order to reproduce the motion of the bed 1 in six directions.

FIGS. 10 to 15 each illustrate only a motion in a single direction, but a complex motion in two or more directions may be implemented according to control of the linear motion of the inner cylinder 421.

According to the present invention, various motions of the bed 1 can be reproduced.

Further, since the initial direction of the bed 1 can be freely changed, the motion of the bed can be reproduced under various conditions.

Exemplary embodiments of the present invention are disclosed for illustrative purposes, those skilled in the art to which the present invention pertains may make various modifications, changes, and additions within the spirit and scope of the present invention, and the modifications, the changes, and the additions fall into the scope of the appended claims.

Those skilled in the art to which the present invention pertains may make various substitutions, modifications, and changes without departing from the technical spirit of the present invention, and thus the present invented is not limited by the embodiments and the accompanying drawings.

### INDUSTRIAL APPLICABILITY

According to the present invention, various motions of an object can be reproduced.

In addition, since an initial direction of a bed can be freely changed, the motions of the object can be reproduced under various conditions.

1. A motion reproduction apparatus comprising:
a bed to which an object for reproducing a motion is coupled;
a first shaft formed on one end of the bed;
a second shaft formed on the other end of the bed; and
a base to which a plurality of driving parts are fixedly coupled,
wherein the first shaft and the second shaft move while connected to the driving parts to reproduce a pitch motion, a roll motion, and a yaw motion of the bed.

2. The motion reproduction apparatus of claim 1, wherein the driving part includes:
a linear motion part of which one end linearly moves within a predetermined range and the other end is coupled to the base; and
an arm of which one end is connected to the first shaft or the second shaft through a spherical bearing and the other end is connected to the one end of the linear motion part.

3. The motion reproduction apparatus of claim 1, wherein the base is divided into:
a fixed base of which relative position with respect to a ground is fixed; and
a variable base of which relative position with respect to the ground is moved,
the variable base is guided and moved by at least one guide part,
the driving part connected to at least one of the first shaft and the second shaft is provided as a first driving part connected to the variable base,
the other driving part other than the first driving part is provided as a second driving part connected to the fixed base, and
as a position of the variable base is moved, an initial direction of the bed with respect to the ground is changed.

4. The motion reproduction apparatus of claim 3, wherein, as the position of the variable base is changed, the initial direction of the bed with respect to the ground is changed within a range of 0° to 90° with respect to the ground.

5. The motion reproduction apparatus of claim 3, wherein each of the first driving part and the second driving part includes:
a linear motion part of which one end is linearly moved within a predetermined range and the other end is coupled to the base; and
an arm of which one end is connected to the first shaft or the second shaft and the other end is connected to the linear motion part.

6. The motion reproduction apparatus of claim 5, wherein one end of the arm is connected to the first shaft or the second shaft through a spherical bearing, and
the other end of the arm is provided with a biaxial connection part which has two pins perpendicular to each other and of which one pin is connected to the other end of the arm and the other pin is connected to the linear motion part.
